(19) United States
(12) Patent Application Publication
(10) Pub. No.: US 2014/0197651 A1
(43) Pub. Date: Jul. 17, 2014

(54) SCOOP BUDDY

(71) Applicant: MARK ANTHONY VAN DER MOLEN, VALPARAISO, IN (US)

(72) Inventor: MARK ANTHONY VAN DER MOLEN, VALPARAISO, IN (US)

(21) Appl. No.: 13/742,424

(22) Filed: Jan. 16, 2013

(51) Int. Cl. A01K 97/01

(52) U.S. Cl. CPC A01K 97/01
USPC 294/179; 294/176

(57) ABSTRACT

An ice fishing device compromising of an ice scoop/skimmer with handle having a proximal and distal end, a retractable device, and an apparartus used to secure the invention to the fisherman or other convenient location. This may be to the ice fisherman's clothing/gear such as but not limited to a belt loop, zipper, pocket, or built-in loop that is commonly found on ice fishing garments. After use and when simply released from the fisherman's hand, this ice scoop/skimmer automatically retracts back to its original position typically near or at the waist level of the fisherman. This invention keeps the scoop in a readily accessible and convenient location after each use and prevents the fisherman from repeatedly bending over to retrieve his/her scoop and also minimizes the chance of losing the scoop/skimmer.

This is a non provisional application that claims priority over a provisional application number 61/631,938 filed on Jan. 17, 2012 with a confirmation number filing receipt of 6485 by the inventor Mark Anthony Van Der Molen 474 S 500 W Valparaiso, Ind. 46385.

### BACKGROUND OF THE INVENTION

1. Field of invention—This invention relates to ice fishing gear and more particularly to a unique retractable ice fishing scoop.

2. Brief Description of the Art—The use of ice scoops/skimmers is very common among ice fisherman. Previously, the ice scoop/skimmer is typically dropped onto the ice after use which leaves the scoop/skimmer in an inconvenient location and requires the fisherman to repeatedly bend over to retrieve his/her scoop. In addition, this increases the chance that the scoop/skimmer might be misplaced or lost. Accordingly, it would be advantageous to provide an ice fishing scoop/skimmer that automatically retracts back to its original location, typically right at or near the waist level of the fisherman. This said invention would be advantageous because it would leave the scoop/skimmer in a more convenient, predictable, and easily accessible location for the fisherman after each use, prevent or minimize the chance of losing the scoop/skimmer, and prevent the need of the fisherman to repeatedly bend over to retrieve his/her scoop. These and other advantages will become apparent from reading the following information.

### SUMMARY OF THE INVENTION

It is an object of the present invention to provide an ice fishing scoop/skimmer that retracts back to its original location after use, typically right at the waist level of the fisherman, which makes it conveniently, predictably, and easily accessible for use.

It is another object of this present invention to provide an ice fishing scoop/skimmer that retracts back to its original location to prevent the fisherman from repeatedly bending over to retrieve the scoop/skimmer from the ice.

It is yet another object of this present invention to provide an ice fishing scoop/skimmer that retracts back to its original location to prevent or minimize the scoop/skimmer being misplaced or lost. Which, unfortunately, is an all too common occurrence known to ice fisherman.

### DETAILED DESCRIPTION OF THE INVENTION

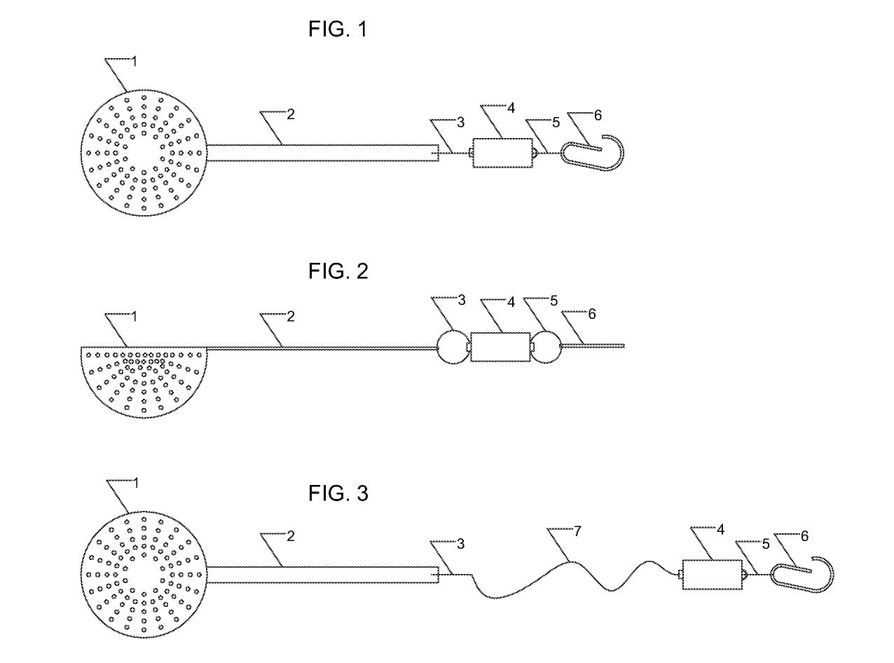

This invention of an ice scoop/skimmer with a retractable feature is very simply operated by using the scoop/skimmer as typically known for scooping shaved ice from an ice fishing hole. In addition, the scoop/skimmer may be used for retrieving minnows or other bait from the fisherman's bait container. What makes this invention unique is its retractable feature. The invention is generally illustrated in FIG. 1. The scoop/skimmer resembles a typical scoop/skimmer with a perforated scoop 1 as to allow water to adequately drain when removing shaved ice from ice fishing holes and a handle 2 that has a proximal and distal end, with a retractable device 4 located at the proximal end of the handle portion of the ice scoop/skimmer opposite of the perforated scoop 1 end. At the end of the retractable device 4 is an apparatus, such as a carabiner 6 or other apparatus which is used to secure the said invention to the fisherman. Rings 5 may be used to secure said handle 2 to said retractable device 4 and said retractable device 4 to said carabiner 6 or other apparatus. This carabiner 6 or other apparatus could be attached to the fisherman or other convenient location, typically on a loop found on the fisherman's clothes such as a belt loop, a side pocket, zipper, or on a built in loop commonly found on most ice fishing suits. The attached location of the said invention would typically be at or around the waist level of the fisherman. When the scoop is used, the handle end is connected to a cable/cord 7 that extends out of the retractable device 4 and is under slight tension. When the fisherman is done using the scoop/skimmer, the fisherman simply releases the scoop which retracts the scoop back to its original location prior to use, typically at or near the waist level of the fisherman conveniently ready for the next use. This invention keeps the ice scoop/skimmer at a convenient location for the fisherman at all times while fishing, prevents the loss or misplacement of the ice scoop, and allows the fisherman to avoid constantly bending over to pick up the scoop off the ice.

### BRIEF DESCRIPTION OF THE ILLUSTRATIONS

Referring to the drawings, the invention herein compromises a retractable ice scoop/skimmer.

FIG. 1 Top view

FIG. 2 Side view

FIG. 3 Top view demonstrates the extended position of said invention.

Said invention as here shown compromises a perforated scoop (FIG. 1,2,3 item 1) having a handle portion (FIG. 1,2,3 item 2) and a retractable device of claim 1 (FIG. 1,2,3 item 4)

Said retractable device of claim 1 (FIG. 1,2,3 item 4) allows for extension and retracts said ice scoop/skimmer and handle via a cord/cable (FIG. 3 item 7)

FIG. 3 Top view demonstrates the extended position of said invention.

The function and utility of the invention relating to ice fishing, from the description herein, is believed to be well understood. It will of course be understood that various changes may be made in the form, composition, details, arrangement and dimensions/proportions of the said invention and in the steps and sequence of steps of the method without departing from the scope and spirit of the inventor's invention which broadly stated, consists in an apparatus and method capable of carrying out the objects set forth, such as disclosed and defined in the claims.

### FIG. 1. Top View (Retracted Position)

1. PERFORATED SCOOP
2. HANDLE
3. RING
4. RETRACTABLE DEVICE
5. RING
6. CARABINER OR SIMILAR APPARATUS

### FIG. 2. Side View (Retracted Position)

1. PERFORATED SCOOP
2. HANDLE
3. RING
4. RETRACTABLE DEVICE
5. RING
6. CARABINER OR SIMILAR APPARATUS

### FIG. 3. Top View (Extended Position)

1. PERFORATED SCOOP
2. HANDLE
3. RING
4. RETRACTABLE DEVICE
5. RING
6. CARABINER OR SIMILAR APPARATUS
7. CABLE/CORD

1. I claim: a retractable ice fishing scoop/skimmer compromising of an ice scoop/skimmer with handle having a proximal and distal end, a retractable device and an apparatus used to secure the invention to the fisherman or other convenient location.

2. The retractable ice fishing scoop/skimmer with handle of claim 1 wherein said scoop/skimmer is disc like or circular, perforated as to allow water to adequately drain when removing shaved ice from ice fishing holes.

3. The retractable ice fishing scoop/skimmer of claim 1 wherein the said disc like or circular scoop attached to the said handle, and at the end of the said handle opposite the said scoop/skimmer end, is attached a retractable device which can be attached to the fisherman or other convenient location via a carabiner or other apparatus which allows the said scoop/skimmer to be extended under tension while typically attached to the fisherman, and then retracted back to its original position when simply released after use.
